(19) United States
(12) Patent Application Publication
(10) Pub. No.: US 2018/0298948 A1
(43) Pub. Date: Oct. 18, 2018

(54) BEARING ARRANGEMENT

(71) Applicant: BENTELER AUTOMOBILTECHNIK GMBH, Paderborn (DE)

(72) Inventors: Johannes BOEKE, Blomberg (DE); Dennis KLEINHANS, Paderborn (DE); Karl-Heinz MUELLER, Lippstadt (DE); Hendrick REINEKE, Bad Driburg (DE)

(21) Appl. No.: 15/934,265

(22) Filed: Mar. 23, 2018

(30) Foreign Application Priority Data
Mar. 24, 2017 (DE) 10 2017 106 418.4
Mar. 19, 2018 (DE) 10 2018 106 365.2

(51) Int. Cl. F16C 33/12; F16C 17/02

(52) U.S. Cl. CPC F16C 33/122; F16C 17/02

(57) ABSTRACT

The disclosure relates to a bearing arrangement, having a metallic bearing receptacle with a bearing socket, a rubber/metal bearing being pressed into the bearing socket, at least one recess being configured in an inner circumferential face of the bearing socket and/or in the outer circumferential face of the outer sleeve, and the rubber/metal bearing having a metallic outer sleeve which is pressed with an interference fit into the bearing socket.

### RELATED APPLICATIONS

The present application claims priority of German Application Number 10 2017 106 418.4 filed Mar. 24, 2017 and German Application Number 10 2018 106 365.2 filed Mar. 19, 2018, the disclosures of which are hereby incorporated by reference herein in their entirety.

### FIELD

The disclosure relates to a bearing arrangement having a metallic bearing receptacle with a bearing.

### BACKGROUND

Bearing arrangements are well known in the field of automotive technology. For example, rubber/metal pairings are used in links of a motor vehicle axle on the end side. Said rubber/metal pairings have twofold functions. Firstly, the link is to be pivotable in a relatively movable manner. Consequently, the rubber/metal pairings have a rotary degree of freedom. Secondly, the rubber/metal bearings damp vibrations.

Furthermore, it is known to use corresponding bearings on motor vehicle axles, for example, in the case of leaf spring arrangements. Rubber/metal bearings are also used here, which rubber/metal bearings firstly provide a rotary degree of freedom, and secondly have damping properties in order to damp vibrations and therefore to provide a smoother driving experience for the motor vehicle occupants.

Corresponding bearing arrangements, for example, of engine mounts or transmission mounts are also known. Here, a corresponding engine block or else a transmission housing is coupled via a bearing to the motor vehicle body.

Here, the rubber/metal bearings are inserted into a bearing housing. Different production methods are known here. It is known to press in the rubber/metal bearings in the axial direction. As the axial pressing-in path increases, however, the force to be overcome for the pressing-in operation also as it were increases and/or shear forces occur which sometimes entail high production costs and/or can cause damage of the bearing.

To this end, it is known from the prior art to split the bearing in two in the axial direction and therefore to insert two bearing parts from opposite sides. The force which is required during pressing in is reduced as a result.

Furthermore, it is known from the prior art to insert the bearing with a looser fit and to adhesively bond or vulcanize it in the bearing socket.

### SUMMARY

It is an object of at least one embodiment of the disclosure to indicate a bearing arrangement which provides an excellent bearing seat with at the same time low waste during the production, with low pressing-in forces.

According to at least one embodiment, the abovementioned object is achieved by way of a bearing arrangement having a metallic bearing receptacle with a bearing socket, a rubber/metal bearing being pressed into the bearing socket, wherein at least one recess is configured in an outer circumferential face of a metallic outer sleeve of the rubber/metal bearing, and the rubber/metal bearing is pressed with the outer sleeve into the bearing socket with an overlap of an interference fit of at least 0.5 mm, forming a clearance as a result of the recess. An embodiment for achieving the abovementioned object is a bearing arrangement having a metallic bearing receptacle with a bearing socket, a rubber/metal bearing being pressed into the bearing socket, wherein at least one recess is configured in an inner circumferential face of the bearing socket, and the rubber/metal bearing has a metallic outer sleeve which is pressed with an interference fit into the bearing socket forming a clearance as a result of the recess.

The bearing arrangement according to one or more embodiments of the disclosure has a metallic bearing receptacle with a bearing socket. The bearing socket is configured with a round cross section, in a circular cross section. A rubber/metal bearing is pressed into the bearing socket.

According to one or more embodiments of the disclosure, the bearing arrangement is distinguished by the fact that recesses in the form of grooves, are configured in an outer circumferential face of a metallic outer sleeve of the rubber/metal bearing. The remaining outer circumferential face which comes into contact with an inner circumferential face of the bearing receptacle forms an interference fit with an overlap of at least 0.5 mm before the pressing-in operation. Within the context of the disclosure, the overlap of the interference fit is greater than 0.8 mm. The overlap should not be greater than 3 mm, however, not greater than 2 mm.

Furthermore, the material of the outer sleeve of the rubber/metal bearing is softer than the material of the bearing receptacle itself. During pressing in with the interference fit, the areas which rub against one another, that is to say the outer circumferential face of the outer sleeve and the inner circumferential face of the bearing receptacle, are reduced, as a result of which the pressing-in force and also the shear force which occurs as a result are reduced. The recesses are distributed on the outer sleeve in a radially circumferential manner and extend in the axial direction of the rubber/metal bearing over the entire length. Therefore, webs are formed between the recesses. During the pressing-in operation, the webs are deformed plastically. This results in a seat of the rubber/metal bearing in the bearing receptacle which is sufficiently firm, being fatigue-resistant. Therefore, an adhesive between the bearing receptacle and the rubber/metal bearing can be dispensed with. It has proven surprisingly positive according to the disclosure that no negative effects for the subsequent firm seat of the rubber/metal bearing in the bearing receptacle result in the case of recesses in the outer circumferential face of the outer sleeve of the rubber/metal bearing. There are greater residual compressive stresses on account of the pressing-in operation in the wall of the outer sleeve in the radial direction below the recesses, and therefore in a groove bottom, than in the wall of the outer sleeve, in which there is no recess. As a result, a correspondingly firm bearing seat of the rubber/metal bearing in the bearing receptacle is realized over a relatively long time period, with the result that bending fatigue loading is also compensated for and does not lead to loosening of the seat of the rubber/metal bearing in the bearing receptacle.

It has likewise surprisingly been shown within the context of the disclosure that the recesses serve a second purpose. If a lubricant is used in order to press in the rubber/metal bearing, a fluid film of the lubricant is formed between the inner circumferential face of the bearing socket and the outer circumferential face of the outer sleeve. When the bearing is pressed in, the fluid film remains between the circumferential faces over the entire time of the bearing seat. If there are then recesses, the lubricant flows into the recesses. The interference fit between the outer circumferential face of the outer sleeve and the inner circumferential face of the bearing socket exerts a corresponding pressure, with the result that the lubricant is pressed out into the recesses and the circumferential faces then lie in direct contact after the pressing-in operation, without a film of lubricant lying in between. This affords the further effect according to the disclosure that the required pressing-out forces are greater in comparison with the required pressing-out force of a rubber/metal bearing without recesses. As a result, the bearing seat is more firm in comparison with a bearing seat without recesses. An example which can be mentioned (which does not restrict the disclosure) is that a rubber/metal bearing without recesses requires a pressing-in force of 100 kN. The pressing-out force would lie at approximately 10 kN. A bearing according to the disclosure with recesses requires only a pressing-in force of 50 kN, in contrast. In relation to the pressing-out force of the rubber/metal bearing without recesses, however, the pressing-out force is to be set here at approximately 20 kN.

Furthermore, rubber/metal bearings are in part also supplied with a wax coating for corrosion protection. This protects firstly the metallic outer sleeve against corrosion and secondly the rubber material against becoming brittle. During the pressing-in operation, the wax layer which is situated between the circumferential faces is then likewise pressed out in the direction of the recesses if it does not already shear off during pressing into the bearing receptacle.

In order to produce the rubber/metal bearing, the outer sleeve is first of all provided. The outer sleeve can be provided as a formed component, but also as an extruded component, from a metallic material, and from a steel material or aluminum material here. An inner sleeve and the rubber are introduced and are vulcanized to the outer sleeve. The outer-side recesses in the outer sleeve can also be produced directly during the extrusion or else can be produced by way of a material-removing machining step. It would also be possible within the context of the disclosure that the recesses are introduced into the outer sleeve by way of a reshaping process.

The rubber/metal bearing is calibrated again after the production operation of the rubber/metal bearing itself. This can ensure that the overlap of the interference fit is maintained before pressing in of the rubber/metal bearing into the bearing receptacle. The diameter of the outer sleeve is reduced during the calibration.

The recesses are themselves of round or rounded configuration in cross section. As a result, a positive profile of the residual compressive stresses in the wall of the outer sleeve is realized during the pressing-in operation and during the subsequent bearing seat.

According to the disclosure, the bearing arrangement is distinguished in a further embodiment by the fact that at least one recess is configured in an inner circumferential face of the bearing socket, and the rubber/metal bearing has a metallic outer sleeve which is pressed with an interference fit into the bearing socket. In addition, the outer sleeve can be coated, for example, with paint. The paint can also yield into the recesses during the pressing-in operation. An air space or clearance remains in the region of the recess. The interference fit has an overlap of at least 0.5 mm even in this variant.

The contact area between the outer circumferential face of the outer sleeve of the rubber/metal bearing and the inner circumferential face of the bearing socket is reduced by way of the at least one recess, a plurality of recesses, on or in the inner circumferential face of the bearing socket. Less friction is produced as a result during the pressing-in operation, which is in turn associated with a reduced pressing-in force. The shear forces which act on the bearing during pressing in are therefore reduced, which reduces the waste during the production of the bearing arrangement according to the disclosure. A sufficiently firm seat of the rubber/metal bearing in the bearing receptacle is ensured by virtue of the fact that an interference fit (also called a press fit) is produced between the outer circumferential face of the outer sleeve and the inner circumferential face of the bearing socket.

In one embodiment, the recesses are configured as grooves. The grooves extend in the axial direction over the entire length of the bearing socket or of the outer sleeve of the rubber/metal bearing. The grooves can also be interrupted in the axial direction. A plurality of grooves are distributed in a radially circumferential manner. The grooves are spaced apart from one another at a uniform spacing. Webs then project in the radial direction between the grooves. The respective webs form the inner circumferential face for receiving the rubber/metal bearing or the outer circumferential face of the outer sleeve. In the following text, the inner circumferential face or outer circumferential face is also called a circumferential face. The circumferential face which is formed by way of the webs is reduced by 10% to 50%, 20% to 40%, or 25% to 30% in comparison with a continuous circumferential face.

In one or more embodiments, the webs are deformed by way of the pressing-in operation. This deformation can be elastic and/or plastic. The webs are pressed flat in part in the radial direction during or after the pressing-in operation. A clearance remains in the recesses, however. The deformation of the webs affords the advantage that the production costs with regard to the tolerances during the manufacture of the bearing receptacle are not increased, since possible oversize tolerances with regard to the webs are compensated for during the pressing-in operation by way of the deformation of the webs. The production costs for manufacturing the bearing socket can therefore be reduced on account of greater possible tolerances despite the production of an interference fit.

The bearing receptacle or outer sleeve itself is produced as an extruded component from a light metal alloy. The bearing receptacle can also be produced from a steel alloy, however. It is possible, during the production using the extrusion process to also produce the recesses which extend in the axial direction at the same time as the extrusion. The production costs for the bearing receptacle are therefore low. Alternative production processes are casting, milling, forging or eroding.

The rubber/metal bearing is configured in one piece in the axial direction. Multiple-piece rubber/metal bearings can also be pushed in in the axial direction, however, two-piece rubber/metal bearings, with the result that in each case one half of a rubber/metal bearing is pressed in from two opposite sides in the axial direction.

The rubber/metal bearing can have the following construction from the outside to the inside in the radial direction: outer sleeve, rubber layer and inner sleeve. The rubber/metal bearing can have further constituent parts in its construction in the radial direction.

In the case of recesses in the bearing receptacle, the outer sleeve is produced from a material which is harder than the material of the bearing receptacle. The outer sleeve is produced from a steel material. The hardness can also be identical and/or the bearing socket and the outer sleeve are produced from the same material. This also applies to recesses in the outer sleeve. The outer sleeve can also be produced from an aluminum material.

Furthermore, the bearing socket has in each case one radially circumferential bevel, a chamfer, at least one axial end. In this way, the pressing-in operation, in the positioning of the rubber/metal bearing for pressing in, is simplified.

The recesses, or grooves, can be of rectangular configuration in cross section. The grooves or recesses can also be of trough-shaped configuration in cross section, or circular section-shaped or rounded.

Furthermore, the bearing arrangement according to the disclosure is distinguished by the fact that no adhesive and/or no lubricant are/is arranged between the inner circumferential face of the bearing socket and the outer circumferential face of the rubber/metal bearing. On account of the production process, the rubber/metal bearing can therefore be pressed in exclusively without the addition of supplementary consumables. This affords the advantage that no chemical reactions take place between the rubber/metal bearing and the bearing socket.

An interference fit is configured with an oversize from 0.5 mm to 3 mm, from 0.8 mm to 2 mm, and, from 0.8 mm to 1 mm. The oversize relates to the difference of the external diameter of the outer sleeve and the internal diameter of the bearing socket.

The disclosure therefore also relates to a method for pressing in or pressing out the rubber/metal bearing into/from the bearing receptacle mentioned in accordance with the disclosure. The bearing socket can be heated for pressing in, the outer sleeve being kept at room temperature or being cold.

Further advantages, features, properties and aspects of the present disclosure are the subject matter of the following description. One or more of the embodiment are shown in the diagrammatic figures.

### BRIEF DESCRIPTION OF THE DRAWINGS

For an understanding of embodiments of the disclosure, reference is now made to the following description taken in conjunction with the accompanying drawings, in which:

FIG. 1 shows a perspective view of a bearing receptacle according to the disclosure,

FIG. 2 shows a front view of a bearing arrangement according to the disclosure,

FIG. 3 shows an embodiment of a rubber/metal bearing with recesses in the bearing receptacle,

FIG. 4 shows a front view of a bearing arrangement according to the disclosure in accordance with FIG. 3,

FIG. 5 shows a detailed cross-sectional view of a recess of a rubber/metal bearing which is pressed into the bearing with a fluid film which escapes into the recess, and

FIG. 6 shows a detailed cross-sectional view with webs which are pressed flat in part in the radial direction.

In the figures, the same reference signs/numerals are used for identical or similar components, even if a repeated description is omitted with for reasons of simplicity.

### DETAILED DESCRIPTION

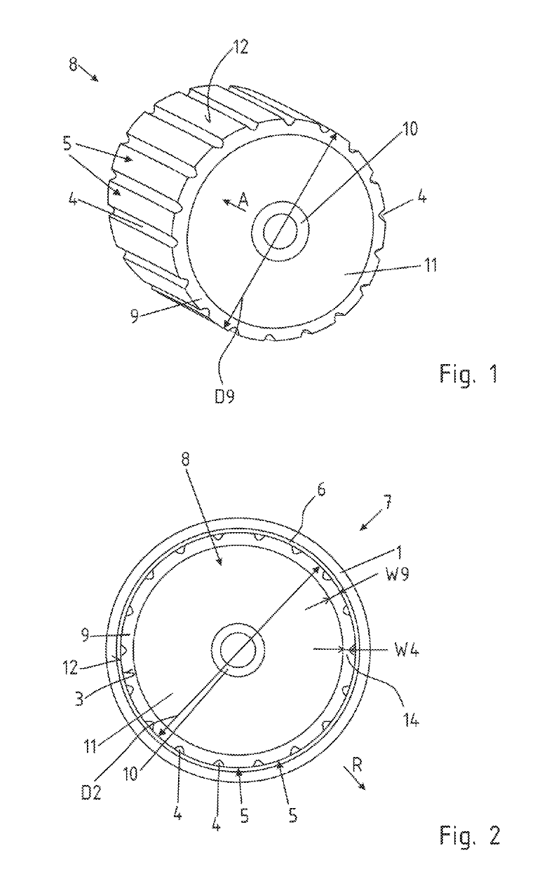

FIG. 1 shows a rubber/metal bearing 8 with an outer sleeve 9. Recesses 4 are configured in the outer circumferential face 12 of the outer sleeve 9. FIG. 2 shows a front view of a bearing arrangement 7, in which the rubber/metal bearing 8 is pressed into a bearing socket 2.

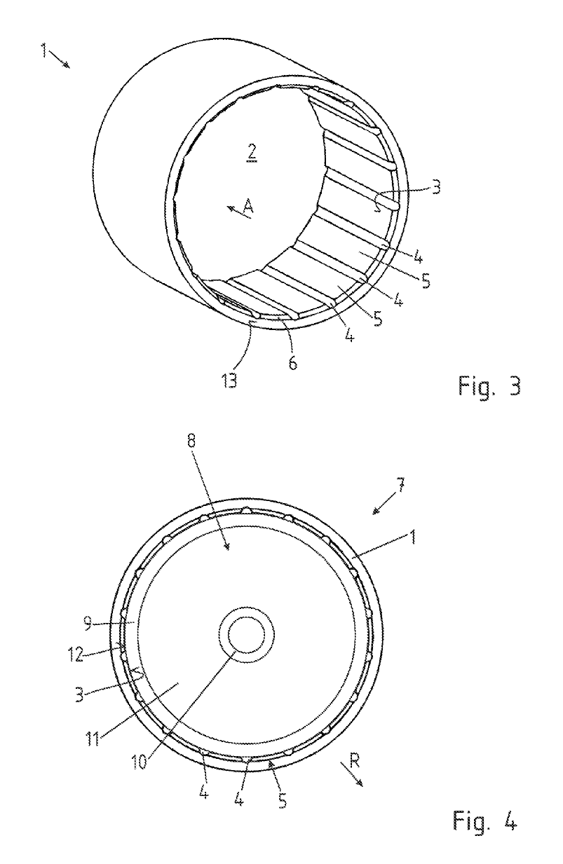

Recesses 4 and webs 5 which are situated between them are therefore configured on the outer circumferential face 12 of the outer sleeve 9, as a result of which the bearing area of the outer circumferential face 12 which comes into positively locking contact in an inner circumferential face 3 of the bearing socket 2 is reduced. The outer sleeve 9 is pressed with an interference fit into the bearing socket 2. A bevel 6 is provided at the axial end of the bearing socket 2 for the pressing-in operation. This can also be seen clearly in FIG. 3. An external diameter D9 of the outer sleeve 9 before being pressed in is always greater than an internal diameter D2 of the bearing socket 2. The overlap is at least 0.5 mm, and consequently the external diameter D9 is at least 0.5 mm, preferably 0.8 mm, greater than the internal diameter D2 of the bearing socket 2. The bevel 6 then makes it possible that the rubber/metal bearing 8 is pressed with the outer sleeve 9 into the bearing socket 2. This results in an interference fit. Here, the webs 5 are deformed by being flattened in the radial direction R. Part of the webs 5 can be deformed into the region of the recesses 4. The webs 5 are deformed at least elastically, and also plastically by way of the pressing-in operation. The recesses 4 themselves are of rounded configuration in cross section, with the result that a higher compressive stress, like residual compressive stress, is configured in a wall thickness W4 in a groove bottom 14 below the recesses 4 than in the wall of the webs 5 with the wall thickness W9. As a result, a firm seat of the bearing is realized even in the case of it being loaded with bearing forces in the form of bending fatigue loading. To this end, the wall thickness W9 is greater than the wall thickness W4. A clearance remains between the recess 4 and the inner circumferential face 3 of the bearing socket 2 after being pressed in. Ambient air and not lubricant or something else is arranged in said clearance.

FIG. 3 shows an alternative bearing receptacle 1 according to the disclosure in a perspective view. The bearing socket 1 is configured as a bearing ring. It can have further attachments (not shown), in order to be attached, for example, to a link or a leaf spring. The bearing receptacle 1 can also be an integral constituent part of a link of this type. The bearing receptacle 1 has an opening in the form of a bearing socket 2. An inner circumferential face 3 has a plurality of recesses 4 which are distributed in a radially circumferential manner. The recesses 4 are configured as grooves which are continuous in the axial direction A. The inner circumferential face 3 is therefore configured by way of webs 5 which project in the radial direction R. The individual webs 5 are interrupted by the respective grooves. The inner circumferential face 3 which is provided by way of the webs 5 is configured so as to be reduced by from 25% to 30% in comparison with a continuous inner circumferential face.

Furthermore, a front axial edge or outer side 13 is of chamfered configuration and, has a bevel 6. If a bearing is therefore attached in the axial direction A and is pressed into the bearing socket 2, simplified attachment for subsequent pressing in is possible.

FIG. 4 shows the bearing arrangement 7 according to the disclosure in a front view. Here, a rubber/metal bearing 8 is pressed into the bearing receptacle 1. The rubber/metal bearing 8 has an outer sleeve 9. Furthermore, the rubber/metal bearing 8 has an inner sleeve 10 and a rubber layer 11 which is arranged between the inner sleeve 10 and the outer sleeve 9. According to the disclosure, an interference fit is configured between the inner circumferential face 3 of the bearing receptacle 1 and the outer circumferential face 12 of the outer sleeve 9. There is in each case a clearance or air space in the recesses 4, even after the pressing-in operation. The webs 5 themselves can be deformed plastically by way of the pressing-in operation, and can be deformed in the radial direction R.

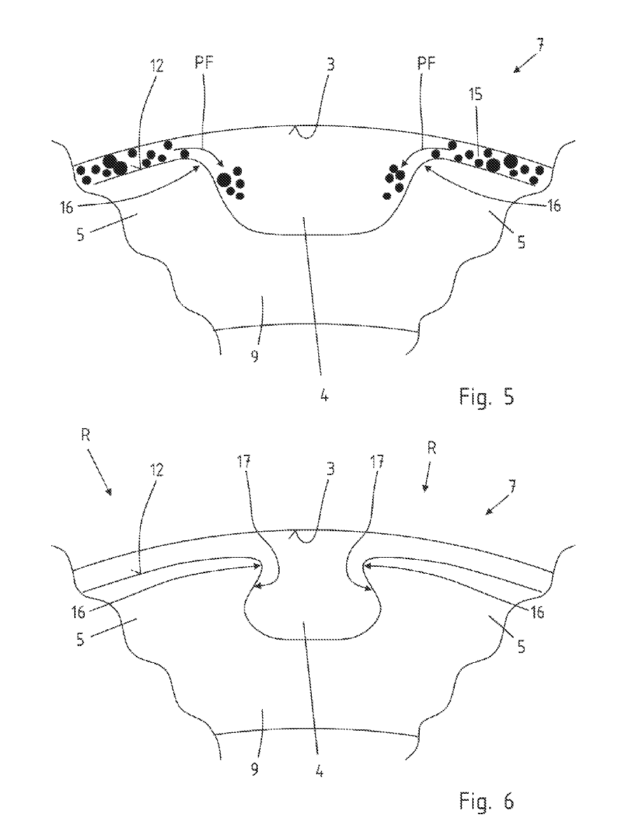

FIG. 5 shows a detailed cross-sectional view through a bearing arrangement 7 with a pressed-in rubber/metal bearing 8. The inner circumferential face 3 of the bearing receptacle 1 comes into positively locking contact with the outer circumferential face 12 of the outer sleeve 9. A fluid film 15 of a lubricant which is utilized during the pressing-in operation is situated in between (shown in an illustrative manner here). The lubricant flows or is displaced in the direction of the direction arrows PF into the recess 4. The outer circumference face 12 and the inner circumferential face 3 therefore bear against one another without a gap and in a positively locking manner. A possible residual fluid film which is still present during the pressing-in operation is displaced in the direction of the recess 4. In order that the fluid film 15 can flow in accordance with the direction arrows PF from a direction between the circumferential faces 3, 12 into the recess 4, the corners 16 are of rounded configuration, with the result that an improved flow of the fluid film into the recess 4 is achieved.

FIG. 6 likewise shows a detailed cross-sectional view. It is shown here that the webs 5 are pressed flat toward the inside in the radial direction R. The circumferential faces 3, 12 once again bear against one another without a gap, which is to be shown diagrammatically here. Side cheeks 17 of the webs 5 are deformed in the direction of the recess 4, since the webs 5 are pressed flat in the radial direction R by way of the pressing-in operation. This can also be combined with the fluid film which is shown in FIG. 5. The corners 16 which are once again rounded are then also configured at the transition from the web 5 to the recess 4.

The foregoing description of some embodiments of the disclosure has been presented for purposes of illustration and description. It is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. It should be understood that various changes, substitutions and alterations can be made hereto without departing from the spirit and scope of the disclosure.

1-13. (canceled)

14. A bearing arrangement, comprising:
a metallic bearing receptacle with a bearing socket, and
a rubber/metal bearing pressed into the bearing socket, wherein
at least one recess is configured in an outer circumferential face of a metallic outer sleeve of the rubber/metal bearing, and
the outer sleeve has an external diameter greater than an internal diameter of the bearing socket by at least 0.5 mm, such that the rubber/metal bearing with the outer sleeve is pressed with an interference fit into the bearing socket, forming a clearance as a result of the recess.

15. A bearing arrangement, comprising:
a metallic bearing receptacle with a bearing socket, and
a rubber/metal bearing pressed into the bearing socket, wherein
at least one recess is configured in an inner circumferential face of the bearing socket, and
the rubber/metal bearing has a metallic outer sleeve which is pressed with an interference fit into the bearing socket, forming a clearance as a result of the recess.

16. A bearing arrangement according to claim 14, wherein
the bearing receptacle is an extruded component of a light metal alloy, and/or
the rubber/metal bearing is configured in one piece in the axial direction of the bearing socket.

17. A bearing arrangement according to claim 15, wherein the outer sleeve is configured from a steel material which is harder than the material of the bearing socket.

18. A bearing arrangement according to claim 14, wherein the outer sleeve is configured from aluminum material or from steel material, the material of the outer sleeve being softer than the material of the bearing receptacle so the outer sleeve is deformed while being pressed into the bearing receptacle.

19. A bearing arrangement according to claim 14, wherein
said at least one recess comprises a plurality of recesses arranged circumferentially on the outer circumferential face of the outer sleeve with webs being configured between the recesses, the webs being deformed plastically by the interference fit.

20. A bearing arrangement according to claim 19, wherein the recess extend in the axial direction of the bearing socket, over the entire axial length of the bearing socket or the outer sleeve.

21. A bearing arrangement according to claim 19, wherein the recesses are configured as depressions of trough-shaped cross section, and/or as grooves.

22. A bearing arrangement according to claim 14, wherein the inner circumferential face of the bearing socket has a radially circumferential chamfer or a bevel, on an axial outer side of the bearing receptacle.

23. A bearing arrangement according to claim 19, wherein the interference fit is achieved between the outer circumferential face which is formed by the webs and the inner circumferential face of the bearing socket.

24. A bearing arrangement according to claim 19, wherein the outer circumferential face which is formed by the webs is reduced in area by 25% to 30% in comparison with an outer circumferential face without recesses and webs.

25. A bearing arrangement according to claim 14, wherein
the wall thickness of the outer sleeve is between 1 mm and 4 mm, and
the wall thickness in the recess is at least 10% lower than the wall thickness of the outer sleeve.

26. A bearing arrangement according to claim 14, wherein, in a state where the rubber/metal bearing has been pressed in the bearing socket, a residual compressive stress in the wall below the recess in the outer sleeve is greater than the residual compressive stress in that wall of the outer sleeve, in which there is no groove.

27. A bearing arrangement according to claim 25, wherein the wall thickness of the outer sleeve is between 1 mm and 3 mm.

28. A bearing arrangement according to claim 25, wherein the wall thickness in the recess is at least 20% lower than the wall thickness of the outer sleeve.

29. A bearing arrangement according to claim 25, wherein the wall thickness in the recess is 20% to 50% lower than the wall thickness of the outer sleeve.
